(19) United States
(12) Patent Application Publication
(10) Pub. No.: US 2012/0171272 A1
(43) Pub. Date: Jul. 5, 2012

(54) STABILIZED BIOCIDAL DISPERSION VIA SUB-MICRONIZED CARRIER PARTICLES, PROCESS FOR MAKING THE SAME AND COMPOSITION THEREOF

(76) Inventors: Raman Premachandran, Saddle Brook, NJ (US); Kolazi S. Narayanan, Wayne, NJ (US); Blanca Gomez, Phillipsburg, NJ (US); Karen Winkowski, Springfield, NJ (US)

(21) Appl. No.: 13/378,423

(22) PCT Filed: Jun. 9, 2010
(86) PCT No.: PCT/US2010/037943

§ 371 Date: Mar. 19, 2012

Related U.S. Application Data
(60) Provisional application No. 61/187,841, filed on Jun. 17, 2009.

(51) Int. Cl. A01N 25/26; A01P 15/00

(52) U.S. Cl. 424/421; 424/409; 424/417

(57) ABSTRACT

A stabilized biocidal dispersion comprising a biocide coated or adsorbed onto stable sub-micron carrier particles and wherein sub-micronized particles are stabilized by additives having polar moieties, hydrophobic and hydrophilic segments. The sub-micron particles are selected from metal oxides like zinc oxide, titanium dioxide, cerium dioxide and silica, alumina, minerals, clays, stilbene and sub-micron carbons. Exemplary biocides include carbamates, isothiazolones, pyrithione chelates and/or trizoles. Also disclosed is a process for preparing stabilized sub-micronized carrier particles.

### FIELD OF THE INVENTION

This invention relates to biocides and more particularly to stabilized biocidal dispersions and the process for preparing the same. The biocidal dispersion disclosed herein is stabilized by stable sub-micronized carrier particles.

### BACKGROUND OF THE INVENTION

US Patent Publication No. 20040120884 discloses nanoparticulate titanium dioxide coating produced by reducing flocculates of titanium dioxide nanoparticles from a titanyl sulfate solution and dispersing the nanoparticles in a polar sol-forming medium to make a solution suitable as a coating usable to impart photocatalytic activity, U.V. screening properties, and fire retardency to particles and to surfaces. The photocatalytic material and activity is localized in dispersed concentrated nanoparticles.

US Patent Publication No. 20040241206 discloses the use of nanoparticles of inorganic materials (e.g., synthetic smectite clays) in ophthalmic compositions. The nanoparticles are utilized as biologically inert carriers or depots for biocides. The nanoparticles are useful in preventing or reducing the uptake of biocides from ophthalmic compositions by contact lenses, when the compositions are applied to the lenses.

US Patent No. 6905698 assigned to Ineos Silicas Limited discloses a particulate carrier material impregnated with a biocidal formulation serving as a vehicle for introduction of the biocide into a liquid-based media, such as a surface coating or surface cleaning compositions, in order to allow controlled release of the biocide to combat bacterial, fungal, algal or like growth for an extend period of time.

U.S. Pat. No. 7,311,766 by Billdal & Kullavik discloses a method for preventing marine biofouling that comprises applying a protective coating to a substrate that contains an imidazole containing compound bound to metal oxide sub-micron-particles and a product for preventing marine biofouling of a substrate comprising a paint that contains an imidazole compound bound to metal oxide sub-micron particles. US Patent Publication No. 20060201379 discloses that Medetomidine, an imidazole compound, is employed to produce antifouling paint and wherein said imidazole compound is bound to metal nanoparticles to develop an efficient antifouling surface and improved performance of antifouling paints.

### SUMMARY OF THE INVENTION

We have discovered that sub-micron particles of a carrier ingredient having a large surface area and small particle size provide an effective interface for coating a biocide and that the use of such sub-micron particles as a biocide carrier will assist in milling the biocide close to the sub-micron meter particle size range making it essentially a sub-micron sized biocide particle. Furthermore, the carrier sub-micron particles can act as a stabilizing interface for the biocide as well as providing enhanced UV-protection on exposure to sunlight. For example, it has been found that sub-micron particles, preferably sub-micron zinc oxide, provide such UV-protection even at a very low concentration while also improving the efficacy of the biocide. Such sub-micron particles, preferably ZnO, also can provide transparent to clear biocide-containing formations. In summary, the sub-micron based and preferably sub-micron ZnO-based biocidal compositions of the invention provide biocidal stabilization, UV-protection, protection from leaching of biocides and enhanced biocidal activity. These dispersions find particular utility in personal care and industrial compositions. Sub-micron particles can be introduced in the biocide compositions with built-in linking polymer species composites or as a sub-micron particle concentrate.

### DETAILED DESCRIPTION OF THE INVENTION

While this specification concludes with claims particularly pointing out and distinctly claiming that which is regarded as the invention, it is anticipated that the invention can be more readily understood through reading the following detailed description of the invention and study of the included examples.

In accordance with this invention, there is provided a stable dispersion composition comprising a biocide coated and stabilized with sub-micron carrier particles. The sub-micron particles can be selected from sub-micron zinc oxide, sub-micron titanium dioxide, sub-micron cerium dioxide and sub-micron silica, sub-micron alumina, sub-micron stilbene, sub-micron carbon and clay particles.

Biocides useful in the practice of the present invention include, but are not limited to, iodopropyny butyl carbamate (IPBC), benzisothiazolinone (BIT), zinc pyrithione, triazole, thiocarbamates and naturally occurring biocides. In a preferred embodiment, the biocide employed for the biocidal dispersion is selected from the group consisting of amine reaction products, 1,2-benzisothiazolin-3-one, 2-bromo-2-nitropropane-1,3-diol (bronopol), 3-iodo-2-propargyl butyl carbamate (IPBC), 5-chloro-2-methyl-4-isothiazolin-3-one (CMTT)/2-methyl-4-isothiazoli-3-one (MIT), bicyclic oxazolidines, glutaraldehyde, N-(trichloromethylthio)phthalimide biocides (Folpet), tetrachloroisophthalo-nitrile biocides, benzisothiazole (BIT), Zinc pyrithone, triazole and/or tetrahydro-3,5-dimethyl-2h-1,3,5-thiodiazine-2-thione. It is believed that the invention can be practiced in conjunction with a wide variety of biocides.

The dispersion can be an aqueous or non-aqueous formulation and the biocide concentration can be present in an amount of 1-40 wt. % of the composition. The sub-micron particles are processed to re-disperse the agglomerated fraction. This is accomplished by using several polymeric compositions with other optional additives (see examples). The stabilized sub-micron particles can be present in an amount of 0.001-20 wt %, preferably from 0.001 to 5% of said composition.

The carrier sub micron particles are processed using polar additives containing polar moieties and hydrophobic segments, capable of binding the sub-micron particles through the polar moieties and adsorbing on to the target biocide via the hydrophobic segments. Examples of such polar additives are compounds containing two or more hydroxyl groups, or carboxylate acids/esters/salts or chelating moieties like thio compounds, nitrogen containing moieties with at least one lone pair of electron per mole. The chelating moieties should be in close proximity separated by not more than ten carbon atoms. Example of such stabilizing compositions include a mixture of hydrophobic polymers along with hydrophilic surfactants preferably anionic and nonionic surfactants with HLB>12 for aqueous dispersions and HLB<12 for non aqueous dispersions.

The dispersions find particular utility in personal care and industrial compositions. In addition to all types of personal care compositions, these biocidal compositions can be used to protect paints and coatings, building materials, stucco concrete, asphalt, caulks, sealants, leather, wood, inks, pigment dispersions, metal working fluids, drilling muds, clay slurries and the like.

The invention will now be described in detail by reference to the following working examples:

Method of Preparation: A typical method consists of mixing 0.1 to 50% weight of ZnO with 0.1-10 Weight % of an anionic wetting agent, 0.01 to 10% of a film forming polymeric deagglomerant/dispersant and water. The mixture is wet grinded in a basket mill using a 0.1 mm ZrO₂ grinding aid (1 to 20 times the weight of metal oxide) until the particle sizes are in the submicron to sub-micron particle size range. Advantage of using the above method is to obtain dispersion of high loading, low viscosity, the medium of dispersion can be either oil or water and it forms a good film.

(Example 1-20). The stabilizing components for the sub-micron particles, as described could be present in the biocide composition for in-situ stabilization or can be provided as a sub-micron particle concentrate which can be added to the biocide formulation.

Further, the present invention is illustrated in detail by way of the below given examples. The examples are given herein for illustration of the invention and are not intended to be limiting thereof.

### STABILIZATION OF SUB-MICRON-PARTICLES IN AQUEOUS SYSTEM

### Example 1

| Ingredient | Wt % |
|---|---|
| ZnO | 40 |
| Styleze 2000 | 2 |
| Sodium dodecyl benzene sulfonate | 4 |
| Water | 54 |

Viscosity 530; pH 8.25, Particle size distribution is D₁₀-0.07 μ, D₂₅=0.095 μ; Dd₅₀=0.113 μ; D₇₅0.26 μ and D₉₀=0.33 μ

Commercially available ZnO from Unicore, Horse head and other suppliers were used to prepare the above dispersions. Styleze 2000 is anionic terpolymer of PVP and acrylic acid from ISP Inc.

All dispersions are prepared by grinding the samples in a basket mill using zirconium bead as grinding aid. The pH of the formulation is 7.5 and the viscosity around 1000 CP. The dispersion is stable after heat aging at 50 C. for 1 month. Good for skin and sun care applications with less whitening.

### STABILIZATION OF SUB-MICROPARTICLE IN NON AQUEOUS SYSTEM

### Example 2

| Ingredient | Wt % |
|---|---|
| Polyethylene glycol (PEG 400) | 89.80 |
| Cyclohexane dimethanol | 0.200 |
| Sub-micron ZnO | 10.00 |

Grinding or milling sub-micron ZnO or TiO₂(0-10%) in PEG 400, propane diol or other solvent mixture to form a non-aggregated, well-dispersed sub-micron particles of ZnO/TiO₂/CeO₂. Propanediol, Easyperse P20, PVP or Styleze 2000 is used to stabilize the sub-micron particles. The resultant dispersion is further diluted and mixed with the corresponding solvent to form transparent or translucent dispersions of required concentration (0.001 to 1%) based on needs.

### COMPARATIVE EXAMPLES OF BIOCIDE (EXAMPLE 3, 4 AND 5) IN WATER USING CONVENTIONAL METAL OXIDE

Method of Preparation: Typical method consists of mixing the ingredients mentioned below in a steel beaker. To the above sample 2 to 20 times the weight of Zirconium beads are added and grinded well in a basket or roller mill until a stable dispersion with particle size in the submicron to sub-micron range is obtained.

### Example 3

| Ingredient | Wt % |
|---|---|
| Water | 72.96 |
| Surfynol CT 111 | 0.50 |
| Pluronic L 101 | 0.50 |
| Easyperse P 20 | 1.5 |
| Regular ZnO | 4.00 |
| IPBC | 20.00 |
| Kelzan | 0.54 |

Viscosity 7530; pH 8.25, Particle size distribution is D₁₀=0.32 μ, D₂₅=0.74 μ; Dd₅₀=1.09 μ; D₇₅ 3.4 and D₉₀=7.2 μ

### Example 4

| Ingredient | wt % |
|---|---|
| Water | 71.26 |
| Surfynol CT111 | 0.70 |
| Easyperse P 20 | 2.50 |
| Regular TiO2 | 5.00 |
| IPBC | 20.00 |
| Kelzan | 0.54 |

Viscosity 6200 CP, pH 5.5, Particle size distribution is D10=0.27 μ; D25=0.65 μ; D50 0.97 μ; D75=2.9 μ and D90=5.9 μ

The stabilization of a 20% active IPBC based formulation requires at least 4% of a regular metal oxide compound. The stabilization with sub-micron metal requires only a very small concentration (e.g. 0.1%). Moreover, the viscosity of the formulation obtained with sub-micron metal oxide and sub-micron organic particles are low compared to one with regular metal oxide or organic particulates.

### EXAMPLES OF BIOCIDE USING STABILIZED FORM OF SUB-MICRON PARTICLES

### Example 5

| Ingredient | Wt % |
|---|---|
| Water | 76.86 |
| Surfynol CT 111 | 0.005 |
| Easy Sperse P20 | 2.00 |
| Sub-micron ZnO (composition from | 0.10 |
| example 1 is added to obtain 0.1% ZnO) | |
| IPBC | 20.00 |
| Kelzan | 0.54 |

The formulation was stable at RT and after heat-aged for one month at 50C. The viscosity was 2000-4500 CP; the pH was 7 to 8.5. The particle size distribution is D10=0.06 μ; D25=0.09 μ; D50=0.29 μ; D75=0.76 μ and D90=1.8 μ

### EXAMPLE OF BIOCIDE DISPERSIONS USING INSITU GNERATED SUBMICRON UV-BLOCKERS (EXAMPLE 6-15)

### Example 6

| Ingredient | Wt % |
|---|---|
| Water | 75.96 |
| Surfynol CT111 | 0.70 |
| Easysperse P 20 | 2.50 |
| Sub-micron TiO₂ | 0.30 |
| IPBC | 20.00 |
| Kelzan | 0.54 |

Viscosity is around 2300-3200 CP, pH is between 5.3 and 6.0. The particle size distribution is D10=0.08; D25=0.103; D50=0.37; D75=0.84 and D90=1.96

### Example 7

| Ingredient | Wt % |
|---|---|
| Water | 76.86 |
| Surfynol CT111 | 0.50 |
| Easysperse P 20 | 2.00 |
| Sub-micron ZnO | 0.10 |
| IPBC | 10.00 |
| Folpet | 10.00 |
| Kelzan | 0.50 |

Viscosity is 1500-3000 CP; its pH was 7.8-8.5.

### Example 8

| Ingredient | Wt % |
|---|---|
| Water | 76.86 |
| Surfynol CT111 | 0.50 |
| Pluronic L 101 | 0.50 |
| EasySperse P 20 | 1.5 |
| IPBC | 20.00 |
| Previously stabilized | 0.10 |
| sub-micornized ZnO | |
| Kelzan | 0.54 |

Viscosity 3000-3500 CP;
pH 7.7-8.3.

### Example 9

| Ingredient | Wt % |
|---|---|
| Water | 77.4 |
| Surfynol CT111 | 0.50 |
| Pluronic L 101 | 1.50 |
| IPBC | 20.00 |
| sub-micronized ZnO | 0.10 |
| Kelzan | 0.50 |

Viscosity is 2000-3000 CP;
pH 7.7-8.3.

### Example 10

| Ingredient | Wt % |
|---|---|
| Water | 74.4 |
| Surfynol CT111 | 0.50 |
| Pluronic L 101 | 0.75 |
| Pluronic L 103 | 0.75 |
| IPBC | 20.00 |
| Sub-micornized ZnO | 0.10 |
| Kelzan | 0.50 |

Viscosity is 1500-2300 CP;
pH 7.8-8.2.

### Example 11

| Ingredient | Wt % |
|---|---|
| Water | 70.9 |
| Surfynol 104E | 0.50 |
| Sub-micornized ZnO | 0.50 |
| BIT | 26.4 |
| Sag 30 | 0.2 |
| Kelzan | 0.50 |

Viscosity 2000-3500 CP,
pH 5.5-6.5

### Example 12

| Ingredient | Wt % |
|---|---|
| Water | 55.6 |
| Easysperse P20 | 2.5 |
| Surfynol CT111 | 0.9 |
| Sub-micron ZnO | 0.5 |
| Zinc Pyrithione | 40.0 |
| Kelzan | 0.5 |

### Example 13

| Ingredient | Wt % |
|---|---|
| Water | 76.86 |
| Easysperse P20 | 2.0 |
| Surfynol CT111 | 0.005 |
| Sub-micron ZnO | 0.10 |
| Propoconazole | 20.00 |
| Kelzan | 0.54 |

### Example 14

| Ingredient | Wt % |
|---|---|
| Water | 72.8 |
| Styleze W20 | 3.5 |
| Sub-micron TiO₂ | 1.0 |
| BIT | 22.7 |

### Example 15

| Ingredient | Wt % |
|---|---|
| Water | 20.0 |
| Thyme | 10.0 |
| Peppermint | 10.0 |
| Balm mint | 10.0 |
| Tea Tree Oil | 10.0 |
| Sub-micron ZnO | 0.5 |
| Tween 20 | 1.5 |
| Pluronic L 127 | 1.0 |

Thyme, peppermint and Balmint extracts were obtained from Ruger chemicals, Tea tree oil was obtained from Trekking company.

### EXAMPLE OF BIOCIDE STABILIZED FROM YELLOWING IN PRESENCE OF SUB-MICRON METAL OXIDES (FROM EXAMPLE 2)

### Example 16

The formulation 11 is diluted with PEG and grinded using zirconium beads to get concentration of sub-micron ZnO in the range of 0.001 to 0.5%. To the sample prepared above, 20% biocides are added and mixed well to dissolve or disperse the biocides in the above solution.

| Ingredient | Wt % |
|---|---|
| PEG 400 | 79.999 |
| IPBC | 20.0 |
| Stabilized sub-micron ZnO | 0.001 |

### Example 17

| Ingredient | Wt % |
|---|---|
| Texanol | 60 |
| Tripropylene glycol ether | 9.999 |
| IPBC | 20.00 |
| Stabilized ZnO | 0.001 |

### Example 18

| Ingredient | Wt % |
|---|---|
| PEG 400 | 79.999 |
| IPBC | 20.00 |
| Stabilized sub micron TiO₂ | 0.001 |

### Example 19

| Ingredient | Wt % |
|---|---|
| Texanol | 60.00 |
| Tripropylene glycol ether | 9.999 |
| IPBC | 30.00 |
| Stabilized sub-micron TiO₂ | 0.001 |

### Example 20

| Ingredient | Wt % |
|---|---|
| PEG400 | 79.999 |
| IPBC | 20.00 |
| Stabilized Sub-micron CeO₂ | 0.001 |

### Example 21

| Ingredient | Wt % |
|---|---|
| Texanol | 60.00 |
| Tripropylene glycol ether | 9.999 |
| IPBC | 30.00 |
| Stabilized sub-micron CeO₂ | 0.001 |

Yellowing of the above samples was measured (Gardner color) at room temperature, after heat aging for 1 month at 50C. or after exposing them to UV irradiation using a Xenon lamp continuously for 6 hours at a controlled humidity. Yellowing was compared to a control that contains no metal ion. Results showed that the presence of sub-micron ZnO, TiO₂, CeO₂ particles were effective even at the 0.001% level to preclude yellowing of the biocide. The samples were clear to transparent at a concentration of 0.05% and below. The product was stable for 1 month at RT and/or heat-aged at 50°C. for the same period of time.

### Example 22

Various biocide formulations (Example 3 and Example 5) were added to standard polyvinyl acetate (PVA) to a final concentration of 500 ppm IPBC.

Drawdown of the paint samples were prepared by casting a 3-mil film onto drawdown paperboard (Lanetta). The drawdown samples were allowed to dry at room temperature for 24 hrs. Strips were cut from each drawdown sample and leached with distilled water at a flow rate of six exchanges for 72 and 96 hrs, followed by drying at room temperature for 24 hrs.

One inch squares were cut from each strip and placed painted-side-up on solidified malt agar. The plates were inoculated with 1.0 mL of a mixed fungal suspension consisting of Aspergillus niger (ATCC 6275) and Penicillium funiculosum (ATCC 11797), each with a concentration of about 10⁷ spores/mL.

The plates were incubated at 28° C. and 85% RH for 28 days. Fungal growth was rated on the surface of the painted sample as indicated in ASTM D5590 on a scale from 0-4 where “0” represents no growth; 1 represents traces of growth (<10%); 2 represents light growth (10-30%); 3 represents moderate growth (30-60%) and 4 represents heavy growth (60% to complete coverage). As shown in Table I, the biocide formulation containing the submicron ZnO provided enhanced biocidal efficacy (less growth) on its surface as compared to the same formulation containing standard ZnO particles.

TABLE I
Efficacy data showing enhanced biocidal activity

| | IPBC | 0 hrs or | | |
|---|---|---|---|---|
| Sample | (in ppm) | No leach | 72 hrs | 96 hrs |
| IPBC dispersion + ZnO | 500 | 0 | 2 | 2 |
| (Example 3) | | | | |
| IPBC dispersion + submicron | 500 | 0 | 1 | 1 |
| ZnO (Example 5) | | | | |

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

We claim:

1. A stabilized biocidal dispersion comprising biocide coated or adsorbed on to stable sub-micronized carrier particles and wherein sub-micronized particles are stabilized with polar moieties, hydrophilic and/or hydrophobic additives.

2. The biocidal dispersion according to claim 1, wherein the biocidal dispersion containing sub-micronized carrier particles is formulated in aqueous or non-aqueous medium.

3. The biocidal dispersion according to claim 1, wherein the carrier sub-micron particles are selected from the group consisting of metal oxide, alumina, silica, stilbene, carbon or clay.

4. The biocidal dispersion according to claim 3, wherein said sub-micronized metal oxide particles are comprised of ZnO, TiO₂ or CeO₂.

5. The biocidal dispersion according claim 1, comprising more than one biocide.

6. The biocidal dispersion according to claim 1, wherein the biocide employed for the biocidal dispersion is selected from the group consisting of amine reaction products, 1,2-benzisothiazolin-3-one, 2-bromo-2-nitropropane-1,3-diol (bronopol), 3-iodo-2-propargyl butyl carbamate (IPBC), 5-chloro-2-methyl-4-isothiazolin-3-one (CMIT)/2-methyl-4-isothiazoli-3-one (MIT), bicyclic oxazolidines, glutaraldehyde, N-(trichloromethylthio)phthalimide biocides (Folpet), tetrachloroisophthalo-nitrile biocides, benzisothiazole (BIT), Zinc pyrithone, triazole and/or tetrahydro-3,5-dimethyl-2h-1,3,5-thiodiazine-2-thione.

7. The biocidal dispersion according to claim 1, wherein the amount of biocide is in the range of about 1 to about 40 wt % of the total composition.

8. The biocidal dispersion according to claim 1, wherein the amount of stabilized sub-micron particles is in the range of about 0.001 to about 20 wt %.

9. The biocidal dispersion according to claim 1, wherein the polar moieties employed to form the stabilized sub-micron carrier particles are selected from the group consisting of carboxylic acids, esters, hydroxyl compounds or chelating compounds and salts thereof and wherein the ratio of sub-micron particles to polar moieties is in the range of about 1:1 to about 1:90.

10. The biocidal dispersion according to claim 1, wherein the hydrophobic additive or polymers employed to form the stabilized sub-micron carrier particles are selected from the group consisting of homopolymers, copolymers and/or terpolymers.

11. The biocidal dispersion according to claim 1, wherein the sub-micronized particles are prepared by means of grinding and/or milling techniques employing suitable dispersing agent and a single or mixture of solvents.

12. The biocidal dispersion prepared according to claim 1 that is UV protective, stabilized from yellowing, leach-proof and capable of providing transparent formulations.

13. The biocidal dispersion prepared according to claim 1 that provides enhanced biocidal activity than the biocidal dispersion which has regular carrier particles.

14. The biocidal dispersion prepared according to claim 1 employed in the field of personal care, paint, coating, building materials, stucco concrete, asphalt caulks, sealants, leather, wood, ink, pigment, metal working fluids, drilling mud, clay slurries and other related industrial applications thereof.

15. The biocidal dispersion prepared according to claim 1 capable of releasing the biocide content from sub-micronized particles in a sustained-release, controlled-release or delayed-release manner.

16. A process for preparing stabilized sub-micronized carrier particles comprising:
i. mixing the carrier particles, hydrophobic polymer, hydrophilic surfactant, polar moieties and a dispersing agent; and
ii. grinding or milling with suitable technique until the carrier particle sizes are in sub-micron ranges.
